(19) United States
(12) Patent Application Publication
(10) Pub. No.: US 2013/0026878 A1
(43) Pub. Date: Jan. 31, 2013

(54) STATOR IN AN ELECTRIC MOTOR

(71) Applicants: Lin Feuerrohr, Rutesheim (DE); Andreas Ewert, Lichtenau (DE); Martin Gutmann, March (DE); Thomas Devermann, Achern-Fautenbach (DE); Bjoern Nommensen, Bad Muender (DE)

(72) Inventors: Lin Feuerrohr, Rutesheim (DE); Andreas Ewert, Lichtenau (DE); Martin Gutmann, March (DE); Thomas Devermann, Achern-Fautenbach (DE); Bjoern Nommensen, Bad Muender (DE)

(73) Assignee: ROBERT BOSCH GMBH, Stuttgart (DE)

(21) Appl. No.: 13/520,334

(22) PCT Filed: Nov. 22, 2010
(86) PCT No.: PCT/EP2010/067883

§ 371 Date: Oct. 1, 2012

(30) Foreign Application Priority Data
Dec. 30, 2009 (DE) 10 2009 055 400.9

(51) Int. Cl. H02K 1/18

(52) U.S. Cl. 310/216.136

(57) ABSTRACT

The invention relates to a stator in an electric motor comprising a plurality of teeth segments forming a stator ring, said teeth segments comprising outer yoke segments and radial support teeth. Connection elements are arranged on the peripheral front sides of the yoke segment and are offset in the direction of the radial outer side.

### BACKGROUND OF THE INVENTION

The invention relates to a stator in an electric motor, in particular in an actuator for a motor vehicle.

EC internal-rotor motors comprising stators are known from prior art, which have a stator ring located radially on the outside and a plurality of support teeth, which are distributed evenly over the periphery and extend radially inwards, for receiving coils through which current can be passed. The stator ring is composed of individual teeth segments, which in each case consist of a return-path segment or respectively a yoke segment and a support tooth, the yoke segments forming the continuous stator ring of the stator in the assembled state. Each tooth segment is composed of stamped sheet metal sheets that are assembled in layers. Such a stator is, for example, described in the Chinese patent publication CN 101442224 A.

Knob-like raised portions or recesses corresponding thereto, which in the assembled state mesh with each other in a positive-locking manner, are provided on the peripheral front sides of the radially outer yoke segments in order to connect the teeth segments, whereby a positive-locking connection results in the radial direction between adjacent teeth segments. The raised portions or recesses are arranged asymmetrically on the peripheral front sides and are offset inwardly with respect to a reference circle through the radial center of the yoke segments.

The problem with such connections is basically that the connection between the tooth segments has to be able to absorb the forces occurring during operation without changing the relative position of adjacent segments. The forces or torques can act in the radial direction, circumferential direction and the axial direction and lead to damage to the connection of adjacent teeth segments.

### SUMMARY OF THE INVENTION

The aim underlying the invention is to specify a stator in an electric motor, which is easy to manufacture, using simple design-related measures, said stator being characterized by a high level of stability and an advantageous magnetic flux profile in the teeth segments of the stator.

The stator according to the invention is used in electrical motors, which especially are used as actuators in motor vehicles, for example as an actuator for seat adjustment or as a servo-motor for steering support. In principle, an application that is independent of motor vehicles is also possible, for example in hand-held power tools. The invention relates to internal-rotor motors, preferably to EC internal-rotor motors.

The stator is composed of a plurality of ring or teeth segments, wherein each ring segment comprises a radially outer yoke or return-path segment and a support tooth extending radially inwards from the yoke segment for receiving in each case a coil through which current can be passed. The support tooth in the teeth segment comprises a base body extending in the radial direction, around which the coil is wound and a tooth crest on the radially inner side, said tooth crest being disposed immediately adjacent to the rotor.

In order to connect adjacent teeth segments, connection elements are disposed on the peripheral front sides of the yoke segments. The connection elements are to be brought into a connecting position so that immediately adjacent teeth segments are connected to each other via the respective yoke segments. The connection preferably occurs in a positive-locking manner, wherein in principle a frictional connection or mixed forms can also be considered. In the case of a positive-locking connection, the connection elements mesh with one another in the peripheral direction so that the positive-locking fit occurs in the radial direction. In addition or as an alternative, a positive-locking fit in the peripheral direction and/or in the axial direction is however also possible.

In the case of the stator according to the invention, connection elements arranged on the peripheral front sides of the yoke segments are displaced radially outwards with respect to a reference circle through the radial center of the yoke segments. The connection elements are therefore situated asymmetrically on the peripheral front sides and lie closer to the outer casing than to the inner edge of the yoke segments of each teeth segment.

Provision is furthermore made for adjacent tooth segments to be connected to each other in the region of the yoke segments by means of a welded seam or joint located in the region of the radial outer side. The weld constitutes a metallurgically-bonded connection between the yoke segments, which is effective in all directions, i.e. in the radial, axial and peripheral directions. In addition to the welded connection, the connection via the connection elements on the peripheral front sides of the yoke segments normally has an effect in the radial direction; thus enabling the welded seam or joint to be relieved via the connection elements at least in the radial direction. Forces acting on the stator in the radial direction are therefore absorbed at least partially via the connection elements on the peripheral front sides of the yoke segments.

The asymmetrical arrangement of the connection elements brings about a radial offset in the direction of the welded seam or joint between the adjacent teeth segments. The distance between the bottom of the welded seam and the joint in the region of the connection elements is reduced, if need be down to zero, so that the weld rim of the welded seam immediately adjoins the separation line between the adjacent yoke segments in the region of the connection elements. In the radial direction, a continuous connection is thereby provided between the adjacent segments across a larger, contiguous section. It is furthermore advantageous for the geometry of the joint line between the adjacent, adjoining peripheral front sides of the yoke segments to undergo a change in direction to the normally radially oriented contact geometry between the segments in the vicinity of the welded seam, whereby the connection is further improved.

In principle an embodiment is also possible, in which the bottom of the welded seam is spaced radially at a certain distance to the connection elements despite said connection elements being displaced radially outwards on the yoke segments.

A further advantage of an asymmetrical arrangement of the connection elements having a position displaced radially outwards is the improved magnetic flux transmission in the peripheral direction between adjacent yoke segments. The magnetic flux lines run in the peripheral direction, wherein due to the asymmetrical arrangement, which is displaced radially outwards, the connection elements on the peripheral front sides cause less interference than is the case for a central arrangement or an arrangement displaced radially inwards.

A further advantage of the inventive connection of adjacent teeth segments is better acoustic characteristics of the stator and the Coulomb frictional losses produced in the joints, whereby the structure-borne noise excitations are dampened better and the emitted airborne noise level is reduced.

A further advantage of the position of the connection elements, which is displaced radially outwards, is that the welding seam or joint can be kept relatively small and yet the distance between said welding seam and the connection elements is reduced. The smaller welding seam can be produced with less energy input. In addition, the delay during the solidification process is less than that for larger welded joints.

The welded seam is, for example, produced with the aid of a laser, wherein other welding methods can also basically be used, for example arc welding such as plasma fusion or WIG welding processes or also electron beam welding.

According to an advantageous embodiment, the peripheral front sides of adjacent yoke segments flatly adjoin one another, wherein the peripheral front sides preferably run in the radial direction and have a planar design. In principle, planar embodiments of the peripheral front sides of the yoke segments which run at an angle with respect to the radial direction are also conceivable or curved peripheral front sides, for example arched peripheral front sides, wherein it is also useful in these cases for said peripheral front sides of adjacent yoke segments to flatly adjoin one another in order to ensure an optimal transmission of force between the teeth segments as well as an optimal magnetic flux.

According to a further advantageous embodiment, the welded seam extends up to a section of the adjoining peripheral front sides, whereat a tangent to the joining region of the peripheral front sides encloses an angle together with a radial through the welded seam. This is especially achieved by virtue of the fact that connection elements on the peripheral front sides are adjacent to the welded seam up to the solidified melting region of said welded seam or lie partially within this solidified melting region. The tangent encloses together with the radial an angle of particularly 30° to 90°, for example 60°. This configuration facilitates the transmission of large forces between the teeth segments without damage to the stator. At the same time, a relatively large joining surface is provided on the peripheral front sides of the yoke segments for receiving large surface forces. The yoke segments flatly adjoin one another in the assembled state in the section of the peripheral front sides, which extends radially between the connection elements and the radially inner yoke segment edge; thus enabling a correspondingly large surface force to be transmitted and the magnetic flux lines to be impaired in the least possible way.

The position of the connection elements is displaced so far radially outwards on the peripheral front sides that the radial distance of a symmetry line, which is placed through the center of the connection elements and runs concentrically to the reference circle, from the radial outer casing of the yoke segments is preferably between 2% and 40% as a percentage of the total thickness in the radial direction of the yoke segments. This means that at a radial distance of the symmetry line from the outer casing of only 2%, the connection elements are disposed in the immediate proximity to the outer casing, whereas at a radial distance of 40%, the connection elements are only relatively slightly displaced radially outwards with respect to the reference circle (50% distance).

In one embodiment of the connection elements as form-fit elements, different form-fit geometries can be considered, for example: concave or convex joint contours of the connection elements, trapezoidal, triangular or rectangular geometries of said connection elements, which if applicable are provided with rounded corners.

### BRIEF DESCRIPTION OF THE DRAWINGS

Further advantages and advantageous embodiments can be extracted from the additional claims, description of the figures and the drawings. In the drawings:

FIG. 1 shows a side view of a teeth segment for a stator in an electric motor, consisting of a radially outer yoke segment which extends in the peripheral direction and a support tooth extending in the radial direction for receiving a coil through which current can be passed,

FIG. 2 shows the teeth segment in a perspective view,

FIG. 3 shows adjacent teeth segments, which adjoin each other with the peripheral front sides on the yoke segments, wherein form-fit elements, which form connection elements, mesh with each other on the peripheral front sides of the yoke segments.

FIG. 4 shows a depiction of a joining region between adjacent teeth segments, which has a welded seam for the metallurgically-bonded connection of the yoke segments that are adjacent to one another,

FIG. 5 shows a similar depiction as in FIG. 4, however in an enlarged view,

FIGS. 6 to 8 show different geometries of the form-fit elements on the peripheral front sides of the yoke segments,

FIG. 9 shows a depiction of the magnetic flux lines through adjacent yoke segments,

FIG. 10 shows a depiction of the asymmetrical arrangement of the form-fit elements on the peripheral front sides of the yoke segments including the specification of the radial displacement.

### DETAILED DESCRIPTION

In the figures, identical components are provided with identical reference numerals.

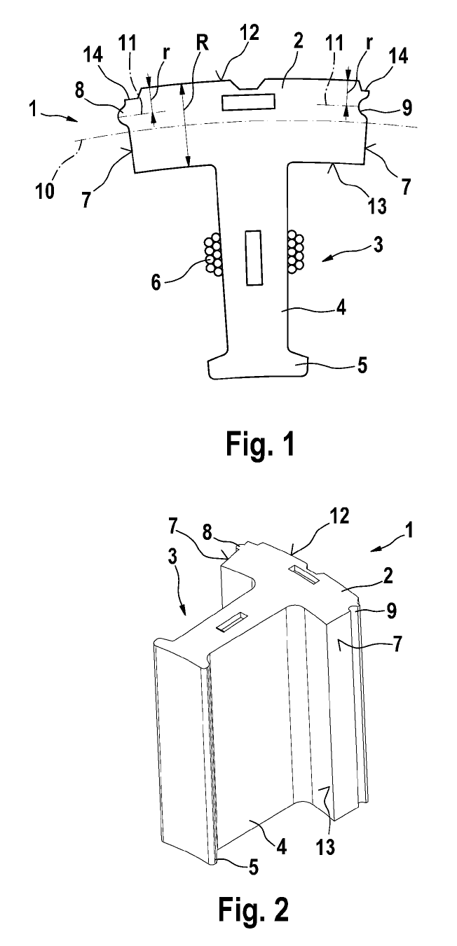

In FIGS. 1 and 2, an individual teeth segment is depicted in each case, which is a constituent part of a stator in an EC internal-rotor electric motor and can collectively compose a stator ring with similar teeth segments. The teeth segment 1 comprises a radially outer yoke segment 2 extending in the peripheral direction and a support tooth 3 which is integrally designed with the yoke segment, extends radially inwards and is the support for a coil 6 through which current can be passed. The support tooth 3 consists of a radially aligned base body 4, the coil being wound around the lateral surface thereof, and a radially inner tooth crest 5 which is widened in the peripheral direction with respect to the base body 4 and forms a pole shoe. The radially inner front side of the tooth crest 5 lies immediately adjacent to the rotor which is enclosed by the stator, wherein an annular air gap is situated between the front side of the tooth crest 5 and the rotor's lateral surface.

The radially outer yoke segment 2 has a greater extension in the peripheral direction than the tooth crest 5 and comprises respectively a form-fit element 8, 9 on the two opposing peripheral front sides 7, wherein the form-fit elements 8, 9 form connection elements on said peripheral front sides 7. The opposing form-fit elements 8 and 9 are designed to complement each other on one teeth segment 1 in order to facilitate a positive-locking engagement of form-fit elements on adjacent teeth and yoke segments.

The yoke segment 2 has a radial extension R. A reference circle between the outer casing 12 and the inner side 13, which leads through the radial center of the yoke segment 2, is denoted with the reference numeral 10 and represents an imaginary marking line in order to illustrate the radial displacement of the form-fit elements 8 and 9 on the peripheral front sides 7 radially outwards in the direction of the outer lateral surface 12. By means of the form-fit elements 8 and 9, which in each case have the same radial offset with respect to the reference circle 10, each symmetry line 11 concentric with the reference circle 10, which has the radial distance r to the outer casing 12 of the yoke segment 2, is positioned. The symmetry line 11 lies offset radially outwards with respect to the reference circle 10. The form-fit elements 8, 9 are therefore situated in the radial direction closer to the outer casing 12 than to the radial inner side 13 of the yoke segment 2. The form-fit elements 8 and 9 are slightly spaced apart from the outer casing 12.

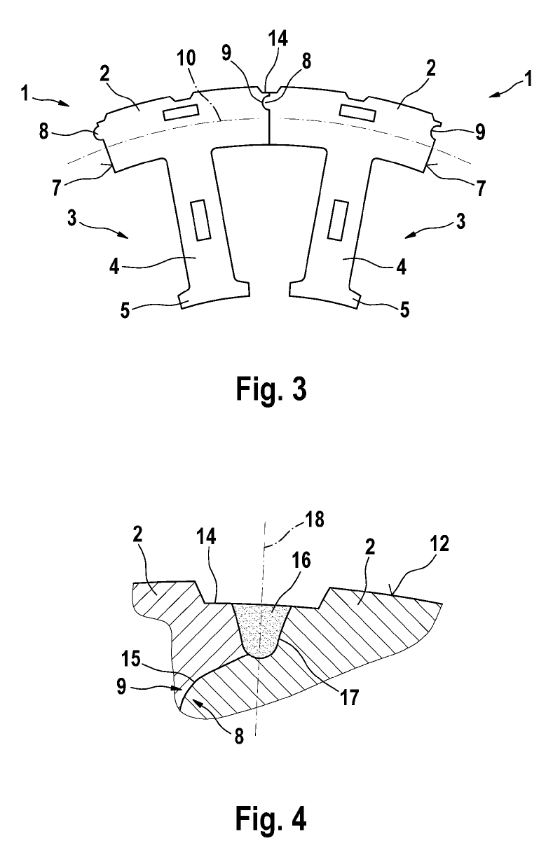

In FIG. 3, two adjacent teeth segments 1 are depicted in the bonded state. The form-fit elements 8 and 9 of facing peripheral front sides 7 on adjacent yoke segments mesh with each other in a positive-locking manner. The form-fit elements are designed as raised portions on the peripheral front sides 7 and have a circular-segment cross section. The form-fit elements 9 are designed complementary thereto as recesses.

The peripheral front side 7 constitutes a rectilinear surface which extends in the radial direction. A region 14, which is radially slightly set back, is situated in the transition between the outer casing 12 and the peripheral front side 7, said region being oriented radially outwards and lying in the joining region in the assembled state of two teeth segments.

The form-fit elements 8 and 9 are designed in such a way that in the assembled state, the raised portion 8 protrudes into the recess 9 in a positive-locking manner, and therefore a positive-locking connection is provided in the radial direction.

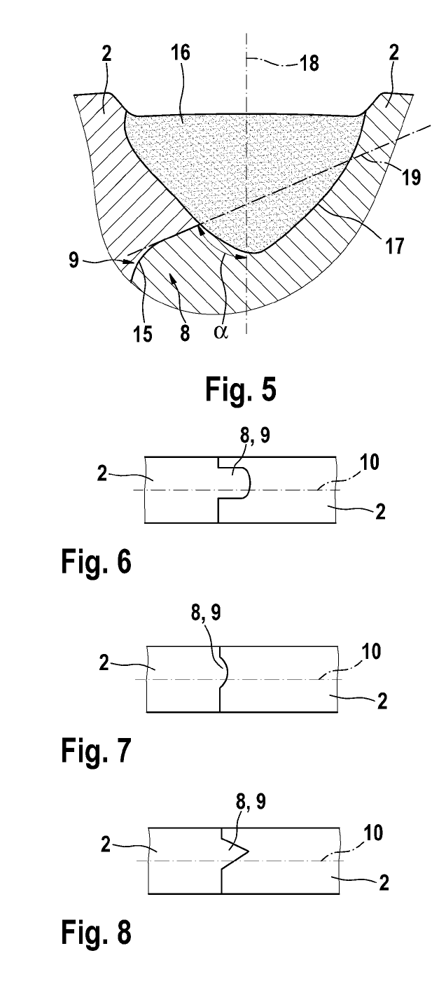

In FIGS. 4 and 5, the joining region between adjacent teeth segments having adjoining yoke segments 2 is shown in an enlarged view. The contact line 15 between the meshing form-fit elements 8 and 9 extends up to a welded seam or joint 16 which is introduced into the setback region 14 on the radial outer side. The welded seam border 17 of the welded seam 16 extends up to a section of the contact line 15, which runs diagonally with respect to a radial 18 that at the same time forms the contact line in the region of the rectilinear peripheral front side. In FIG. 5, a tangent 19 to the contact line 15 is placed at the point of intersection of said contact line with the welded seam border 17. The tangent 19 together with the radial 18 takes up an angle a, which is between 30° and 90° and amounts to approximately 60° in the exemplary embodiment. The welded seam 16 preferably extends across the entire axial extent of the teeth segment 1, can however alternatively also be designed axially in sections or axially in a dot-like fashion.

In FIGS. 6 to 8, different exemplary embodiments are depicted for form-fit elements 8, 9 on the peripheral front sides of the yoke segments 2. Pursuant to FIG. 6, the form-fit elements 8, 9 have an approximately rectangular basic cross-section comprising a circular-segment tip or circular-segment base.

Pursuant to FIG. 7, the form-fit elements are designed as an arc.

Pursuant to FIG. 8, the form-fit elements 8, 9 have a triangular cross-section. In all of the exemplary embodiments, the form-fit elements 8, 9 are offset radially outwards with respect to the reference circle 10 through the yoke segments 2.

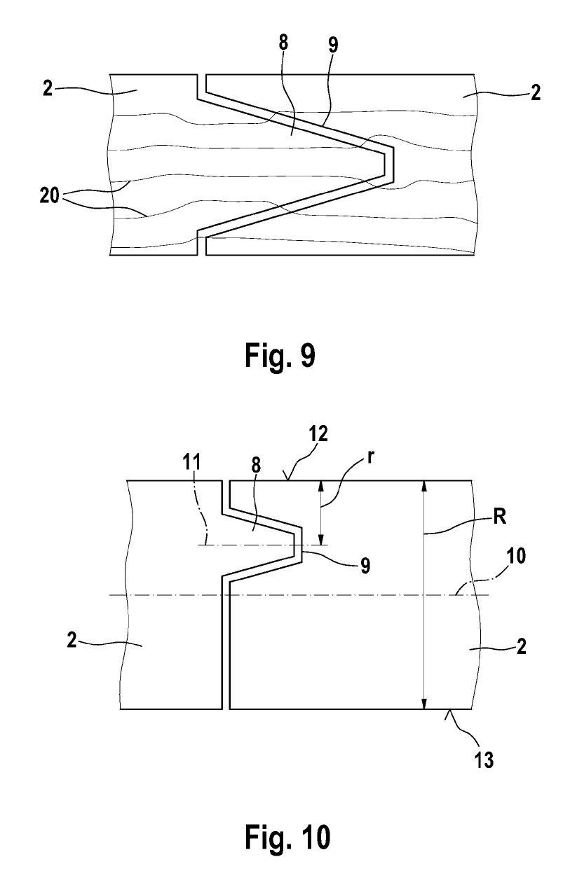

A further exemplary embodiment comprising two assembled yoke segments 2 is depicted in FIG. 9. Said yoke segments are provided with trapezoidal form-fit elements 8, 9, which mesh with each other in a positive-locking manner. In addition, the magnetic flux lines 20 through the yoke segments 2 are depicted in FIG. 9. The magnetic flux lines 20 run in the peripheral direction and deviate only relatively little from their course even in the region of the form-fit elements 8 and 9.

In FIG. 10, the radial displacement of the form-fit elements 8, 9 in the direction of the outer casing 12 is shown once again. The distance r from the symmetry line 11 through said form-fit elements 8, 9 with respect to the outer casing 12 amounts to 2% to 40% when seen as a percentage of the radial thickness R of the yoke segment between the outer casing 12 and the inner side 13. Said form-fit elements 8, 9 are therefore offset radially outwards with respect to the reference circle 10 through the yoke segments 2.

The stator according to the invention can also be a constituent part of other electrical machines—as, for example, a generator.

1. A stator in an electric motor, comprising a plurality of separately manufactured teeth segments (1), which form a stator ring and comprise support teeth (3) for receiving coils (6) through which current can pass, the teeth segments also comprising radially outer yoke segments (2) that form an outer side of the stator ring and from which the support teeth (3) extend radially inward, wherein connection elements (8, 9) for connecting adjacent yoke segments (2) are arranged on peripheral front sides (7) of the yoke segments (2) and the connection elements (8, 9) are arranged on said peripheral front sides (7) at a radial distance to a reference circle (10) through a radial center of said yoke segments (2), characterized in that the connection elements (8, 9) on said peripheral front sides (7) are offset radially outwards with respect to the reference circle (10) and in that adjacent teeth segments (1) are connected to each other by means of a welded seam (16) which is situated in a region of the radial outer side.

2. The stator according to claim 1, characterized in that the peripheral front sides (7) of adjacent yoke segments (2) flatly adjoin one another.

3. The stator according to claim 2, characterized in that the welded seam (16) extends up to a section of the adjoining peripheral front sides (7), whereat a tangent (19) to said peripheral front sides (7) together with a radial (18) through the welded seam (16) enclose an angle (α).

4. The stator according to claim 3, characterized in that the angle (α) is between 30° and 90°.

5. The stator according to claim 1, characterized in that a radial distance of a symmetry line (11) through the connection elements (8, 9) from a radial outer casing (12) of the yoke segments (2) is between 2% and 40% of a radial thickness of said yoke segments (2).

6. The stator according to claim 1, characterized in that the welded seam (16) extends radially up to the connection elements (8, 9).

7. The stator according to claim 1, characterized in that the peripheral front sides (7) of the yoke segments (2) are planar and extend in a radial direction.

8. The stator according to claim 1, characterized in that the connection elements are configured as form-fit elements (8, 9).

9. The stator according to claim 1, characterized in that the connection elements (8, 9) are integral with the yoke segments (2).

10. An electrical machine having a stator according to claim 1.

11. The stator according to claim 4, characterized in that a radial distance of a symmetry line (11) through the connection elements (8, 9) from a radial outer casing (12) of the yoke segments (2) is between 2% and 40% of a radial thickness of said yoke segments (2).

12. The stator according to claim 11, characterized in that the welded seam (16) extends radially up to the connection elements (8, 9).

13. The stator according to claim 12, characterized in that the peripheral front sides (7) of the yoke segments (2) are planar and extend in a radial direction.

14. The stator according to claim 13, characterized in that the connection elements are configured as form-fit elements (8, 9).

15. The stator according to claim 14, characterized in that the connection elements (8, 9) are integral with the yoke segments (2).
